(19) United States
(12) Patent Application Publication
(10) Pub. No.: US 2023/0105432 A1
(43) Pub. Date: Apr. 6, 2023

(54) PERFORMING MOVEMENTS OF FUNDS WITH COMPLIANCE

(71) Applicant: STRIPE, INC., San Francisco, CA (US)

(72) Inventor: Katharine Lauer, San Francisco, CA (US)

(21) Appl. No.: 17/487,637

(22) Filed: Sep. 28, 2021

(51) Int. Cl. G06Q 20/10

(52) U.S. Cl. CPC G06Q 20/10

(57) ABSTRACT

A method and apparatus for performing movements of funds with compliance. In some embodiments, the method comprises analyzing, by a payment processing system, attributes of each movement of funds performed by the payment processing system; identifying, by the payment processing system, one of a plurality of pipes based on the attributes of said each movement of funds, each pipe of the plurality of pipes having one or more rules that include one or more gates to determine whether funds may be moved, by the payment processing system, between sender and receiver accounts designated for said each movement of funds and one or more controls to apply during or after said each movement of the funds; performing, automatically by the payment processing system as a result of identifying the one pipe, one or more actions for applying the one or more rules and the one or more controls of the one pipe to ensure said each movement of funds complies with regulatory requirements of a plurality of jurisdictions; and completing, by the payment processing system, said each movement of funds if performing the one or more actions indicates said each movement of funds complies with the regulatory requirements of a plurality of jurisdictions.

### FIELD OF THE INVENTION

Embodiments of the present invention relate to the field of systems for processing commercial transactions; more particularly, embodiments of the present invention relate to ensuring money movements associated with payment processing for commercial transactions occur with regulatory compliance.

### BACKGROUND

Today, many merchants use third parties to handle all their payment processing needs for commercial transactions. In some cases, the merchants redirect their customers to the third party, who is responsible for capturing the payment information and processing the transaction, or the merchants capture payment information themselves from their customers and send it to a third-party payment gateway for real-time authorization of transactions and subsequent settlement of funds.

Transaction tracking software is often used to track transactions and store data related to the transactions. In the context of payment processing for commercial transactions, the data that is tracked shows the movement of money in payment processing. Data associates with the commercial transactions are usually stored to enable one or more parties to access the transaction data for tracking and/or audit purposes.

Different countries and jurisdictions determine which money movements of transactions need to be regulated. That is, each country and/or jurisdiction can specify different money movements that need to be tracked and for which reporting is required. Thus, when payment processing software is to be created for a new country and/or jurisdiction, a determination is required as to what must be tracked for reporting and then the software must be configured to meet the regulatory requirements. This is a very time-consuming process that does not scale as deployments occur in new countries and/or jurisdictions.

### SUMMARY

A method and apparatus for performing movements of funds with compliance. In some embodiments, the method comprises analyzing, by a payment processing system, attributes of each movement of funds performed by the payment processing system; identifying, by the payment processing system, one of a plurality of pipes based on the attributes of said each movement of funds, each pipe of the plurality of pipes having one or more rules that include one or more gates to determine whether funds may be moved, by the payment processing system, between sender and receiver accounts designated for said each movement of funds and one or more controls to apply during or after said each movement of the funds; performing, automatically by the payment processing system as a result of identifying the one pipe, one or more actions for applying the one or more rules and the one or more controls of the one pipe to ensure said each movement of funds complies with regulatory requirements of a plurality of jurisdictions; and completing, by the payment processing system, said each movement of funds if performing the one or more actions indicates said each movement of funds complies with the regulatory requirements of a plurality of jurisdictions.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 shows a flow diagram of the steps and entities for implementing payment processing.

FIG. 2 is a data flow diagram of some embodiments of a process for mapping movement of funds with attributes.

FIG. 3 is a flow diagram of some embodiments of a process for processing transactions.

FIG. 4 illustrates data flow through an example pipe in accordance with some embodiments of the present invention.

FIG. 5 is a data flow diagram of some embodiments of a process for handling movements of funds.

FIG. 6 is a block diagram of some embodiments of a computer system.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Techniques are disclosed herein for handling transactions involving that movements of funds (e.g., payment flows) made by a payment processor and its associated payment processing system(s). That is, the transactions involve the movements of funds that are performed, at least in part, by the payment processor. Note that a payment processor may include multiple payment processing systems that perform all or a subset of the functions described herein.

In some embodiments, the movement of funds are performed and completed in a way that ensures that the movement of funds satisfies regulatory requirements of one or more jurisdictions (e.g., all jurisdictions for which the payment processor is involved with at least a portion of the movement of funds, etc.). In some embodiment, the movement of funds are made in a way that ensures that the movement of funds satisfies licensing or other contractual requirements of one or more financial partners (e.g., financial partners of the payment processor).

In some embodiments, the techniques disclosed herein enable changes to be made to the jurisdictions and/or financial partner requirements to create a new set of jurisdictions/financial partner requirements so that movements of funds are performed and completed in accordance with the new set of jurisdictions/financial partner requirements.

Certain terminology is used herein for convenience only and is not to be taken as a limitation on the present invention.

Embodiments of the present invention is described in the context of an online payment acceptance service called Stripe® commercialized by Stripe, Inc., San Francisco, California.

The following definitions are provided to promote understanding of the present invention.

Card Network (or Card Association) - refers to financial payment networks such as Visa®, MasterCard®, American Express®, Diners Club®, JCB® and China UnionPay®.

Processor - A processor is a company (often a third party) appointed to handle credit card transactions. They have connections to various card networks and supply authorization and settlement services to merchants or payment service providers. They can also move the money from the issuing bank to the merchant or acquiring bank.

Acquiring Bank - An acquiring bank (or acquirer) is the bank or financial institution that accepts credit and or debit card payments from affiliated card networks for products or services on behalf of a merchant or payment service provider.

Card Issuing Bank - A card issuing bank is a bank that offers card network or association branded payment cards directly to consumers. The issuing bank assumes primary liability for the consumer’s capacity to pay off debts they incur with their card.

Payment Information - In some embodiments, for making payment via a credit card or debit card, the payment information includes primary account number (PAN) or credit card number, card validation code, expiration month and year. In another embodiment for making payment via an Automated Clearinghouse (ACH) transaction, the payment information includes a bank routing number and an account number within that bank. The payment information includes at least some sensitive, non-public information.

Merchant - A merchant, as used herein, is an entity that is associated with selling or licensing products and/or services over electronic systems such as the Internet and other computer networks. The merchant may be the direct seller/licensor, or the merchant may be an agent for a direct seller/licensor. For example, entities such as Amazon® sometimes act as the direct seller/licensor, and sometimes act as an agent for a direct seller/licensor.

Merchant Site - The merchant site is the e-commerce site (e.g., website) of the merchant. The merchant (100) and merchant server (120) in the figures are associated with the merchant site. The merchant site is associated with a client-side (client side) application and a server-side (server side) application. In some embodiments, the merchant site includes Merchant Server (120), and the server-side application executes on the Merchant Server (120).

Customer’s Electronic Device - This is the device that the customer uses to interact with the merchant. Examples of this device include a desktop computer, a laptop computer, a mobile device (e.g., smartphone, tablet) and game console. The customer’s electronic device may interact with the merchant via a browser application that executes on the device, or via a native application (app) installed onto the customer’s device. The client-side application executes on the customer’s electronic device.

Payment Processor - A payment processor, as referred to herein, is an entity or a plurality of entities that facilitate a transaction between a merchant site and a customer’s electronic device. The payment processor includes selected functionality of both Stripe (300) and Processor (400)/Card Networks (500). For example, in some embodiments, Stripe (300) creates tokens and maintains and verifies publishable (non-secret) keys and secret keys in a manner well-known in the art. See for example, U.S. Pat. Nos. 10,134,036, 9,830,596, and 9,824,354. The Processor (400)/Card Networks (500) is involved in authorizing or validating payment information. In some embodiments, Stripe (300) and the Processor (400)/Card Networks (500) function together to authorize and validate payment information, issue a token, and settle any charges that are made. Accordingly, in some embodiments, the payment processor refers to the functionality of Stripe (300) and the functionality of the Processor (400)/Card Networks (500). In another preferred embodiment wherein step 3A in the high-level description is not performed, and Stripe (300) performs its own verification before issuing a token, the Processor (400)/Card Networks (500) are still used for settling any charges that are made, as described in step 7A in the high-level description. Accordingly, in this embodiment, the payment processor may refer only to the functionality of Stripe (300) with respect to issuing tokens.

Native Application - A Native Application or “native app” is an application commonly used with a mobile device, such as a smartphone or tablet. When used with a mobile device, the native app is installed directly onto the mobile device. Mobile device users typically obtain these apps through an online store or marketplace, such as an app store (e.g., Apple’s App Store, Google Play store). More generically, a native application is designed to run in the computer environment (machine language and operating system) that it is being run in. It can be referred to as a locally installed application. A native application differs from an interpreted application, such as a Java applet, which requires interpreter software. A native application also differs from an emulated application that is written for a different platform and converted in real-time to run, and also differs from a Web application that is run within the browser.

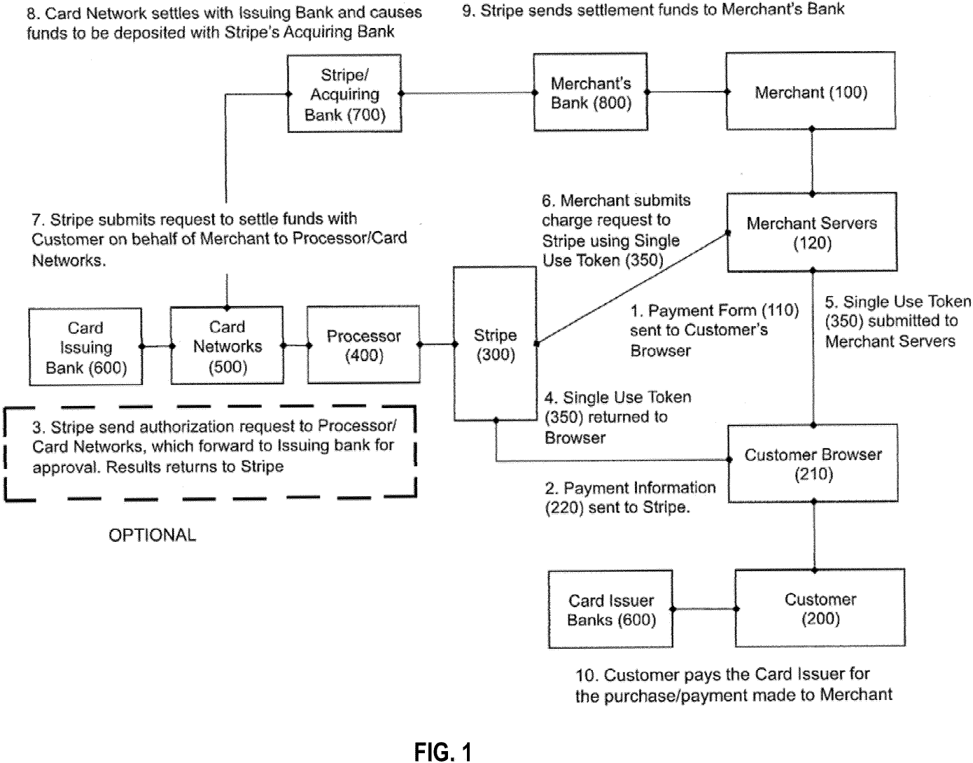

FIG. 1 shows a flow diagram of the steps and entities for implementing payment processing flow embodiments of the present invention.

At a high level, the payment processing framework described herein works as follows (FIG. 1):
1. A Merchant’s Customer (200) uses an internet-enabled browser (210) to visit the Merchant’s site. In some embodiments, Customer (200) is served a Stripe.js enabled Payment Form (110) using standard web technologies. Stripe.js is well-known in the art. For more information on Stripe.js, see U.S. Patent Nos. 10,134,036, 9,830,596, and 9,824,354. The Customer (200) enters the necessary information including their Payment Information (220) and submits the Payment Form (110). The Billing Info portion of the Payment Form (110) is for payment via a credit card or debit card. If payment is to be made via an Automated Clearinghouse (ACH) transaction, the Billing Info portion of the Payment Form (110) will request a bank routing number and an account number within that bank, and possibly additional information, such as the bank name and whether the account is a checking or savings account.
2. The Customer’s payment information (220) is sent from the Customer’s browser (210) to Stripe (300), never touching the Merchant’s Servers (120). In this manner, the client-side application electronically sends payment information retrieved from the customer’s electronic device to the payment processor. The client-side application does not send the payment information (220) to the server-side application.
3. In some embodiments, Stripe (300) submits the relevant transaction to a Processor (400) or directly to the Card Network (500) for authorization or validation of the payment information. The Card Network (500) sends the request to the Card Issuing Bank (600), which authorizes the transaction. In this embodiment, Stripe (300) and Processor (400)/Card Network (500) function together as a payment processor. In another embodiment, this step is performed without any communication to the Processor (400)/Card Network (500). Instead, Stripe (300) performs its own authorization or validation of the payment information using heuristic means, such as by checking the Bank Identification Number (BIN), also referred to as the Issuer Identification Number (IIN), against a database of known valid BINs that is on file with Stripe (300). (The BIN is a part of the bank card number, namely the first six digits.) In yet another embodiment, this step is not performed at all since the authorization or validation is not necessary for the next step 4 to succeed. That is, it is acceptable to create a Single-use Token in step 4A that represents payment information which has not been validated in any way.
4. If authorized, Stripe (300) will generate and return a secure, Single-use Token (350) to the Customer’s Browser (210) that represents the customer’s payment information (220) but doesn’t leak any sensitive information. In the embodiment wherein step A3 is not performed, Stripe (300) performs this step without waiting to receive authorization from the Processor (400) or the Card Network (500). In this manner, the payment processor (here, Stripe (300)) creates the Token (350) from the payment information sent by the client-side application, wherein the Token (350) functions as a proxy for the payment information (220).
5. The Payment Form (110) is submitted to Merchant’s Servers (120), including the Single-use Token (350). More specifically, the payment processor sends the Token (350) to the client-side application, which, in turn, sends the Token (350) to the server-side application for use by the server-side application in conducting the transaction.
6. The Merchant (100) uses the Single-use Token (350) to submit a charge request to Stripe (or to create a Customer object for later use). In this step, Stripe (300) submits a request to authorize the charge to the Processor (400) or directly to the Card Network (500). This authorization specifies the actual amount to charge the credit card. If an authorization was already done in step 3A for the correct amount, this authorization request can be skipped. This may be a one-time payment for a merchant item, or it may involve registering the payment information with the merchant site for subsequent use in making a payment for a merchant item (so-called “card on file” scenario). Using the process described in steps 1-6, the payment information can be used by the server-side application via the Token (350) without the server-side application being exposed to the payment information.
7. Stripe (300) settles the charge on behalf of the Merchant (100) with the Processor (400) or directly with the Card Network (500).
8. The Card Network (500) causes the funds to be paid by the Card Issuing Bank (600) to Stripe (300) or to Stripe’s Acquiring Bank (700).
9. Stripe (300) causes the settled funds to be sent to the Service Provider (100) (or to the Merchant’s Bank (800)), net of any applicable fees.
10A. The Card Issuing Bank (600) collects the paid funds from the Customer (200).

### Movement of Funds in Payment Processing Flows

In some embodiments, the payment processor, using one or more payment processing systems, performs movements of funds as part of transaction processing, while ensuring each movement meets regulatory and/or contractual requirements. In some embodiments, this is accomplished by mapping generic movements of funds to their requirements and the payment processor determines whether to complete the money movement based on rules (regulatory requirements) across all jurisdictions/in accordance with applicable requirements (including contacts with financial partners).

In order to handle the performance of such fund flows, the payment processor uses a taxonomy that enables the management of the regulatory and financial partner requirements that apply to each different fund flow across all jurisdictions. Specifically, instead of determining the regulatory requirements that apply to financial products of the payment processor individually, jurisdiction by jurisdiction, the payment processor identifies elemental, individual fund flows (e.g., payments, transfers, refunds, returns, loan disbursements, loan repayments, etc.) and handles each individual fund flow.

In some embodiments, the payment processor handles the fund flows using a plurality of pipes, each of which handles a particular fund flow. In some embodiments, for each pipe, and thus, each fund flow, the payment processor uses a set of open attributes (e.g., sender, receiver, source of funds, destination, jurisdiction of sender and receiver, currency) and a set of rules that include (i) go/no gates that determine whether the payment processor is permitted to move the funds between the sender and recipient and (ii) controls that apply during the money movement or afterwards. In some embodiments, the attributes of any fund flow traveling through a pipe determine (i) which jurisdictions apply, (ii) whether the funds pass through the gates, and (iii) how the specific requirements direct the actions of the payment processor. In some embodiments, the attributes determine which pipes of a plurality of pipes to apply to a fund flow. In some embodiments, for each pipe, the payment processor maps the regulatory requirements and the appropriate financial partner requirements to the transactions and its associated movement of funds.

As pipes apply different sets of rules, the payment processor uses attributes to trigger different rules and different outcomes with respect to each movement of funds based on those rules.

In some embodiment, transactions are tagged with the attributes and the payment processor examines the tags to make decisions of whether to complete the movement of funds based on policies. That is, the payment processor decides whether a movement of funds goes forward or not based on the policies. In some embodiments, the payment processor uses predetermined tagging for different types of money movement/fund flows that have different purposes and have different requirements (e.g., regulatory requirements, financial partner requirements, etc.) of all jurisdictions in which movements of funds are made, at least in part, by the payment processor. When a transaction has been tagged with certain attributes, the payment processor is able to determine (e.g., look up) the requirements for a transaction with those attributes and completes the movement of funds associated with the transaction if the movement of funds complies with those requirements. In this way, the attributes and processing the transactions based on those attributes ensures that the movement of funds by the payment processor associated with the transactions is moved for a particular purpose and passes through a set of requirements associated with that purpose.

In some embodiment, the payment processor abstracts rules from the specific requirements in each jurisdiction where the payment processor is licensed and/or regulated and uses a set of defined terms, a selected language and formatting that connects each rule back to the requirements from which it is derived so that funds flowing through a pipe trigger each abstracted rule to fetch the specific requirement in the jurisdiction that should be applied.

In some embodiment, two or more of the pipes are linked together. Linking discrete segments creates efficiencies and avoids multiple repetitive (and possibly conflicting) mappings.

In some embodiments, each pipe accommodates all jurisdictions for which the payment processor is involved in at least a portion of the movement of funds. In such a case, the attributes, pipes, abstracted rules and requirements operate and the regulatory and financial partner requirements are applied to all fund flow across all jurisdictions in an automated manner. In some embodiments, all fund flows are visible, traceable, and reportable.

In some embodiments, a common language is used for modeling money movements at a payment processor. The language can be used to integrate and enforce regulatory and compliance policies and/or financial partner requirements into systems that are involved in payment processing operations, such as, for example, the operations described above. In some embodiments, the language is a domain-specific language (DSL) specialized to the payment processing domain. In some embodiments, the DSL is composed of two separate layers to simplify and isolate the way money movements are categorized from a regulatory point of view with the way a payment processor (e.g., Stripe) operates internally. The layers are referred to herein as the regulatory layer and the movement of funds mapping layer. In some embodiments, the layers define their own specific terms which hold special meaning in their respective contexts (e.g., intent, contracts, etc., for example, in the regulatory layer and top-ups (adding money or credit to an account), payees, global payouts, etc., for example, in the movement of funds mapping layer).

In some embodiments, the language is used to express regulated money movements in a payment processing software and a number of countries in which they are deployed. In some embodiments, the language is abstract in that it is not limited to use in a particular architecture or data modeling environment. For example, the language may be used in a Global Payments and Treasury Network (GPTN) implementations.

In some embodiments, the language is used to identify specific types of money movements and then initiate an action on them. Examples of actions include, but are not limited to, labeling (e.g., tagging) certain money movements as regulated in some way (e.g., US Money Transmission (MT), EU e-money, etc.) or applying a policy to the money movements. For example, in some embodiments, the language is used to apply a policy such as restricting specific types of activity (e.g., a cross-border activity), as well as other activities.

The language uses a data model for organizing data structures within a payment processing database and payment processing platform. The data model enables requests (e.g., queries) and responses to those requests.

In some embodiments, the language represents money movements as a series of transactions between accounts. In some embodiments, this representation resembles a graph in the computer science sense. The language employs a number of rules. In some embodiments, for each jurisdiction, a set of rules is created, with one rule set per layer. In some embodiments, the rules are, at a high level, similar to filled out templates that are constructed by providing specific values for the data model fields and layer-specific terms. In some embodiments, the language supports multiple, overlapping sets of rules which would enable identifying money movements such as US Federal MT rules and US Colorado State MT rules at the same time.

Note that for some embodiments, an account is an entity that can hold a balance(s) of money. Money can be sent to or from an account, and each account has a physical address that is used to determine its jurisdiction. An example of an account is a merchant (or payee) of the payment processor (e.g., Stripe). In some embodiments, an account can also be a corporate entity of the payment processor (e.g., SINC for US Stripe fees) or a partner of the payment processor (e.g., Regions Bank for issuing sweeps).

Also, for some embodiments, a transaction is a movement of funds, of a specific type, between a “to account” (a destination account) and a “from account” (an originating account). In some embodiments, the type is used to distinguish between different funds (e.g., regulated versus unregulated, etc.) in a jurisdiction-specific way (e.g., US Money Transmission (MT) vs Payment Processing (PP) funds).

In some embodiments, the data model for the transaction includes one or more of the time and date of the transaction, an amount and currency of both the sent and received funds (where different currencies for the sent and receive funds indicates that a currency conversion occurred), information about the “from account” and the “to account” at the time of the transaction (e.g., a physical address, etc.).

In some embodiments, the data model for the transaction specifies some limited information about the history of the funds traveling through or by the payment processor (e.g., Stripe) to arrive at their current location. Such information may include the manner in which the funds were initially entered, the jurisdictions that the funds touched, previously assigned colors/tags, etc.). Note that in other embodiments in which carrying forward information is less expensive (computationally) and restrictive (implementation-wise), more history (e.g., the entire history) regarding the transaction that specifies the history of a specific set of funds arriving a specific point in in the payment processor (e.g., Stripe).

Note that in some embodiments, product transactions (e.g., payout) are broken out into REML transactions of a specific type and vary based on the underlying representation. In the case of representation as a transaction graph, the product transactions is decomposed into multiple parts based on their original inflows into the payment processor (e.g., Stripe). However, in the balances world, product transactions are decomposed into multiple parts based on the distinct balance pairs from which the data is pulled or into which the data is put.

In some embodiments, the language is used by setting up a regulatory or contractual and then making the regulatory rule/contractual rule operational. With respect to the regulatory rule, to setup tagging in a new jurisdiction, the rules are initially written in the regulatory layer. In some embodiments, rules in this layer use terms that have meaning in a regulatory context but don’t directly map to the payment processor’s software (e.g., Stripe’s products). A simple example would be: if the account doesn’t have a contract with the payment processor, then tag the transaction as regulated. The same applies to financial partner contractual requirements.

In order to operationalize the regulatory rule, a description about the manner in which the rule is applied to an activity (movement of funds) occurring within the payment processor is used. In some embodiments, this is accomplished by building a payment processor movement of funds mapping rule. In many cases, this is a straight mapping of a regulatory term to a payment processor’s movement of funds. Continuing the simple example from before, the regulatory term, the account doesn’t have a contract with the payment processor, can be mapped to the movement of funds concept, the account is a payment processor payee (e.g., it’s not a Stripe merchant).

A global tagging system (GTS) internally maps these payment processor (e.g., Stripe) movement of fund terms to the data models in the payment processor codebase. Continuing the example, in some embodiments, the GTS examines payment processor movement of fund transactions (e.g., transfers, payouts, etc.) and, if those transactions happen on a payment processor payee, the GTS tags them as regulated.

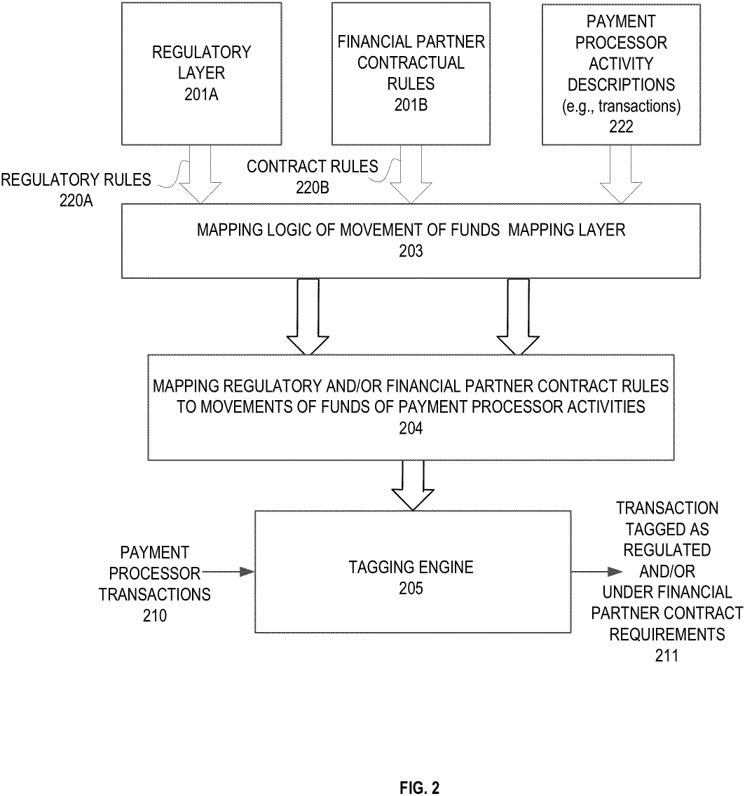

FIG. 2 is a data flow diagram of some embodiments of a process for mapping movement of funds with attributes. In some embodiments, the process is performed by processing logic that may comprise hardware (circuitry, dedicated logic, etc.), software (e.g., software running on a chip), firmware, or a combination of the three. In some embodiments, the process is performed by a payment processing system of a payment processor.

Referring to FIG. 2, regulatory layer 201A generates and includes regulatory rules 220A. Financial partner contract layer 201 generates and includes financial partner requirement rules 220B. Regulatory rules 220A and financial partner requirement rules 220B are provided to mapping logic of the product mapping layer 203 along with movement of funds descriptions 222 (e.g., payment processor-involved transactions).

In response to these inputs, the mapping logic of the product mapping layer 203 generates a mapping 204 of regulatory rules 220 financial partner requirement rules 220B to the movements of funds and their payment processor activities. Tagging engine 205 uses mapping 204 of regulatory rules 220A and financial partner requirement rules 220B to the payment processor activities to categorize the movement transactions of the payment processor, such as transactions 210 of the payment processor. In some embodiments, tagging engine 205 includes attributes tagging logic that tags transactions of the payment processor, such as transactions 210 of the payment processor, with attributes that indicate the movement of funds associated with individual transaction are regulated and/or under financial partner contractual requirements. In some embodiments, tagging logic of tagging engine 205 tags transactions of the payment processor, such as transactions 210, as regulated or not. Tagging engine 205 outputs transactions tagged with attributes as transactions 211.

In some embodiments, the factors for rules that may be considered for regulatory rules involving money transmission may include one or more of the following factors: location of source account (e.g., a US account, a non-US account), location of destination account (e.g., a US account, a non-US account), whether locations of source and destination account are different; the intent of the transmission (e.g., whether the transmission is for goods, services or something else (e.g., stored value card), whether the goods or services are themselves a money transmission, the legal relationship between the account receiving the money transmission and the payment processor (e.g., whether a payment processing contract exists between the account and the payment processor, whether a standing arrangement to transfer funds exists, etc.), whether the funds have been received by the payment processor or by recipient, whether a non-BSA (Bank Secrecy Act) regulated bank is involved in the transaction, whether incoming payment is to oneself or other person; whether the transfer is a cross-border transaction within the payment processor or not; expected settlement date of funds; whether the payment processor is taking the funds for fees; whether the entity is purchasing electronic money from an account of the payment processor; whether a EPA Credit Transfer (SCT) is involved in the transfer; whether a fund transfer to a different account is allowed for the receiver; whether the funds are moving to a different payment processor; whether a currency exchange or foreign currency is involved on the funds being transferred, whether the funds are being transferred within the payment processor; whether stored value cards, electronic cash or direct debit services; and whether the payout must occur within a particular time frame (e.g., within one day, within two days, etc.). Some of the factors above are used by themselves or in combination with other factors specified above or not specified above. Thus, the above list of factors is not meant to be the only factors that are used in rules and not all of these factors need to be used in rules.

### Example Process Flows

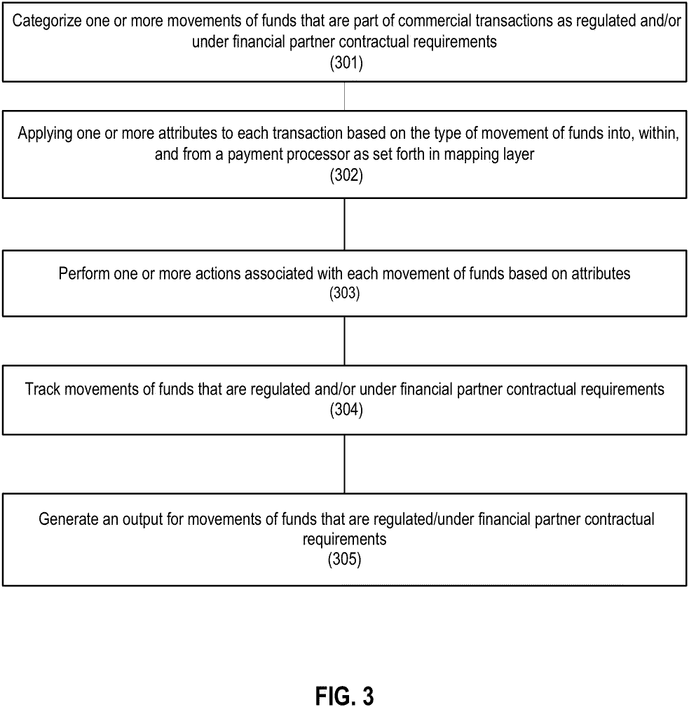

FIG. 3 is a flow diagram of some embodiments of a process for processing transactions. In some embodiments, the processes are performed by processing logic that may comprise hardware (circuitry, dedicated logic, etc.), software (e.g., software running on a chip), firmware, or a combination of the three. In some embodiments, the process is performed by a payment processing system of a payment processor.

Referring to FIG. 3, the process begins by categorizing one or more movements of funds that are part of commercial transactions as regulated and/or under financial partner contractual requirements (processing block 301) and applies one or more attributes to the movement of funds associated with each commercial transaction (processing block 302). In other words, categorization of each movement of funds is indicated by the attributes that have been associated with the commercial transaction. In some embodiment, the attributes are associated with the commercial transactions, and it’s movement of funds, by tagging the commercial transactions with the attributes.

In some embodiments, categorizing the one or more movements of funds as regulated is based on the assigned physical address of at least one of the originating and destination accounts. In some embodiments, each of the one or more movements of funds is between an originating account and a destination account, and each of the originating account and the destination account has an assigned physical address for determining its jurisdiction.

In some embodiments, the one or more movements of funds are related to payment processing operations of the payment processor, and each of the one or more movements of funds is represented as a series of transactions between originating and destination accounts indicative of a sequence of individual flow funds takes into, within and from the payment processor.

After categorization and application of attributes, processing logic performs one or more actions associated with each movement of funds based on the characterization and its attributes (processing block 303). In some embodiments, one of the actions comprises applying a policy. In some embodiments, the policy restricts a type of activity (e.g., cross border activity, etc.).

Processing logic tracks movements of funds that are regulated and/or under financial partner contractual requirements (processing block 304) and automatically generates an output for movements of funds that are regulated and/or under financial partner contractual requirements (processing block 305). In some embodiments, the output comprises a regulatory report required for one or more jurisdictions (e.g., countries).

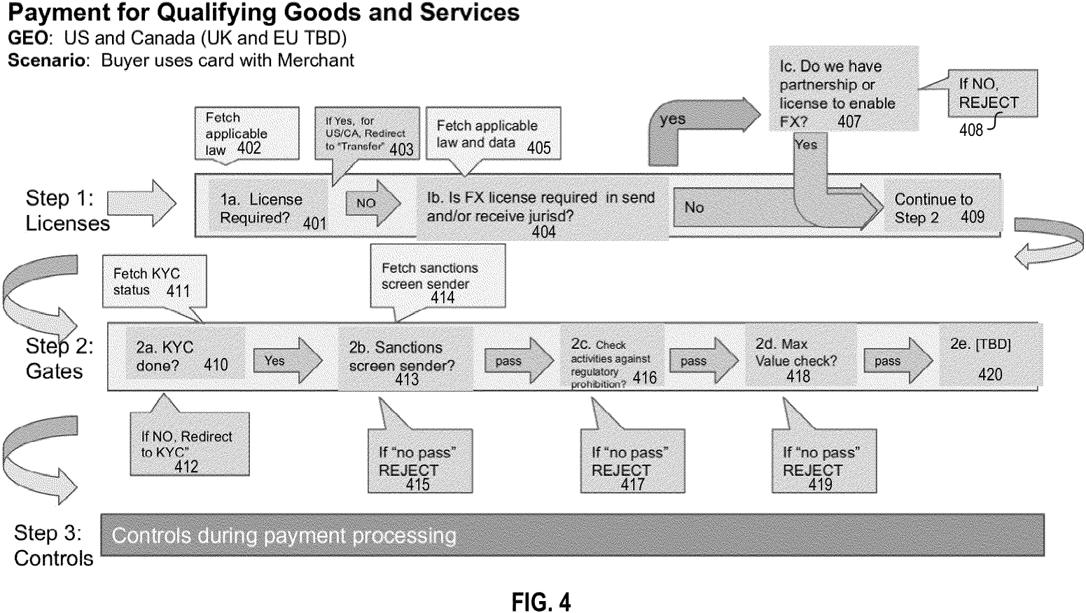

FIG. 4 illustrates embodiment by a pipe for handling one of a plurality of movements of funds that may be performed by some embodiments of a payment processor. In some embodiments, the pipe is for handling payments for qualifying goods and services in which accounts in the US and Canada are involved in the movement of funds and where the buyer uses a card with a merchant.

The selection of the pipe of FIG. 4 to process a particular movement of funds with the pipe is based on attributes attached to the payment transaction. In an example transfer funds, the payment transaction attributes comprise an indication of the transaction type, an indication of where that the transaction involves qualifying goods and services, an identification of the sender, an identification of the source of the funds being moved (e.g., source account), an indication of the jurisdiction in which the source resides, an indication of the recipient, an indication of the designation account into which the funds are sent, an indication of the designation jurisdiction, an indication of an amount sent, and an indications of the amount received, an indication of the initiating entity that initiated the movement of funds, and an indication of the setting entity.

In some embodiments, the pipe is broken down into three sections involving three steps in the processing of a particular movement of funds. In some embodiments, each of the steps is performed sequentially in the order set forth in FIG. 4. However, in alternative embodiments, the order of in which the steps are performed may be changed. Also, in alternative embodiments, the performance of portions of one or more of the steps are interleaved with the performance of portions of one or more other steps.

Referring to FIG. 4, the first step (Step 1 - Licenses) in the pipe is determining whether licenses apply an applying the requirements of any such licenses. After the determination that licensing requirements have been met with respect to the movement of funds, the payment processing system proceeds to perform the second step (Step 2 - Gates) in the pipe. Step 2 involves the application of “go” or “no-go” gates that are applied to determine whether the movement of funds can continue. Finally, if the payment processing system determines that the movement of funds has made it through all the gates, then the payment processing system performs the third step (Step 3 - Controls) in the pipe which consists of controls that are necessary for a particular movement of funds are employed during the payment processing. Examples of the licensing requirements, gates and controls are discussed in greater detail below.

With respect to licenses, the payment processing system starts by determining whether a license is required for a movement of funds (401). To determine this, the payment processing system fetches the applicable law (402). If so, in the case of this example payment for goods and services with the US and Canada involved, the processing of the movement of funds is redirected to a transfer pipe (403).

If a license is not required, the payment processing system checks whether a foreign exchange (FX) license is required in the jurisdictions from which funds are sent and to which the funds are sent (404). To perform this function, the payment processing system fetches the applicable law and data in order to make the appropriate determination of whether a foreign exchange license is required (405). If so, the payment processing system determines whether there is a partnership or license to enable the foreign exchange (407), and if not, a movement of funds is rejected and the funds are returned to the sender’s account (408). On the other hand, if no foreign exchange license is required in either of jurisdictions of the sender’s account or the receiver’s account, or if there is a partnership for licensing a foreign exchange, the payment processing system transitions to Step #2 where the payment processing system applies the go/no-go gates to the movement of funds (409).

A pipe may apply other financial services licensing requirements. One such financial services licensing requirement is a country nexus requirement. For example, the US state and federal law and regulations apply for transaction involved funds transition activities occurring in the US. Therefore, if either the source or destination jurisdiction attributes is the US, then the funds are being transmitted in the US and the requirements of the state and federal laws are applied to the movement of funds. Another financial services licensing requirement involves the US federal Money Services Business (MSB). In this case, if the transaction does satisfy the payment processing exemption requirements, then the US MSB license requirements should be applied to the movement of funds, and if the transaction does satisfy the US state payment processing exemption requirements, then the transaction should be processed through the payment pipe of FIG. 4. Another example of financial services licensing requirement involves the State money transmission licenses (MTLs). In this case, if the transaction does not satisfy the agent to the payee (AOP) exemption requirements, then State MTL license requirements are required to the movement of funds, and if the transaction does satisfy the AOP exemption requirements, then the transaction should be processed through the payment pipe of FIG. 4. Other financial services licensing requirements may be applied by one or more pipes and would be known to those skilled in the art.

At Step #2, a series of go/no go gates are employed to determine whether the movement of funds can continue. In the case of the movement of funds with respect to a payment for goods and services handled by the pipe in FIG. 4, the payment processing system checks whether a Know Your Customer (KYC) analysis has been performed on the sender and the receiver of the movement of funds under one or both of banking laws (e.g., the Bank Secrecy Act) and agreements with financial partners (410). If not, the payment processing system is redirected to the KYC processing engine to perform the KYC analysis. If the KYC process has been done and the sender and the recipient have been approved, the payment processing system determines whether sanction screening has been performed on the sender and the recipient of the movement of fund (413). If the sanction screening indicates that no funds may be passed to by the sender or to the recipient, the movement of funds is rejected and the funds are returned to the sender’s account (415). If the sender and recipient passes the sanction screening, the payment process system checks whether the activities involved in the movement of funds are against a regulatory prohibition (416). If they are, the movement of funds is rejected and the funds are returned to the sender’s account (417). If the activities involved in the movement of funds are not against the regulatory prohibition, then the payment processing system checks whether the movement of funds is above a predetermined maximum (418). If they are, the movement of funds is rejected and the funds are returned to the sender’s account (419). If the amount of the funds that are being moved is not above the maximum, then the payment processing system processing of Step #2 is completed and the processing of the movement of funds moves to Step #3 where the controls are employed.

Note that the pipe of FIG. 4 may employ one or more other gates to determine whether the movement of funds may be completed and thereafter transitions to Step #3. Other examples of go/no go gates of pipe in FIG. 4 include, determining whether the sender or recipient are on a restricted business list. In this case, if the transfer transaction is being used to facilitate either the sender or recipient’s business, then as long as the sender and/or recipient’s business is not listed on the RBL (restricted business list) or if the sender and/or recipient has been waived by the payment processer and its financial partners, then the transaction can proceed. If neither the sender nor the recipient have payment processer accounts, then the RBL would not apply to the sender or recipient. Other go/no-go gates may be applied by one or more pipes and would be known to those skilled in the art.

At step #3, a series of one or more controls are employed with respect to the movement of funds by the payment processing system to complete the pipe (421). Non-limiting examples of such controls include a transfer include determining whether eligible securities are impacted by the movement of funds, generation of receipts for the movement of funds, providing disclaimers, and performing transaction level monitoring. If an eligible securities control is part of the pipe, the payment processer is required to hold certain liquid assets referred to as eligible securities or permissible investments with a market value of at least equal to the aggregate amount of the payment processor processes such as any payment instruments, stored value obligations and money received for transmission in the United States. Therefore, for transfer of funds to be completed, the payment processing can only occur if the transfer does not violate the holdings requirement associated with the eligible securities. If a receipts requirement control is part of the pipe, then the payment processer must provide a receipt to the sender for all transfers at the time of the transfer as part of complete the movement of funds. If a disclaimer requirement control is part of the pipe, then the payment processer must provide disclaimer disclosures that inform customers that they may contact certain state regulators with any complaints regarding this payment processer’s money transmission services. If a transaction level monitoring requirement control is part of the pipe, then the payment processer performs transaction level monitoring on the transactions associated with the movement of funds. In some embodiments, the transaction level monitoring consist of a series of risk-based rules that identify transactions that represent an elevated level of risks of money laundering.

Other controls that potentially may be part of a pipe include, but are not limited to, suspicious activity reports (SARs), transition timing, refund timing, recordkeeping, escheatment, and regulatory reporting. With respect to SARs control, if a transaction is flagged as suspicious, it may be processed and payout may occur; however, the payment processor must also file a SAR as part of the controls. With respect to the transmission timing control, if a transfer takes longer than a predetermined period of time (e.g., a maximum number of days) to settle the recipient, the payment processer will review and determine if a delay was consistent the sender’s instruction or needs to be remediated. With respect to a refund timing control, if a sender requests a refund of transfer before the payment processer affects the transfer, the payment processer refunds the transfer to the sender within a predetermined number of days of receipt of the first request. With respect to a recordkeeping control, the payment processor is required to maintain records of the user and the transaction in accordance with the payment processer’s policies. With respect to an escheatment control, if the designation account is inactive for an applicable state dormancy, then the payment processor applies escheatment policy requirements. With respect to regulatory reporting control, the payment processor identifies tag transfers and includes responses to queries as appropriate in regulatory reporting.

The movement of funds associated with a payment for goods and services a process by the pipe set forth in FIG. 4 is one example of a movement of funds. In some embodiments, other movements of funds have their own dedicated pipe. For example, there may be a number of pipes needs to handle a number of types of fund flows that include payment, transfer, issuance of GPTN stored value, refund, return, loan disbursement, loan repayment, debit payment card funding, credit payment card funding, treasury account funding and payment account funding, which are as follows:
1) Payment: funds sent by sender to recipient in exchange for qualifying goods or services;
2) Transfer: funds sent by sender to recipient that does not fall under any of the other types of fund flows;
3) Issuance of GPTN Stored Value: payment processer issues (sales) GPTN stored value to a user;
4) Refund: reversal of payment;
5) Return: reversal of transfer;
6) Loan Disbursement: a one-time financing (namely, a loan or a merchant cash advance) where the user is extended funds for a fee, and such funds are repaid over time;
7) Loan Repayment: a payment processer user makes a loan repayment to the payment processer (for an amount owed to the payment processer or a person on behalf of whom the payment processer is acting as a loan servicer);
8) Debit Payment Card Funding: payment processer transfers funds from a user’s payment processer account balance to a prepaid/debit payment card balance issued by the payment processer or a financial institution with which the payment processer has partnered to issue payment cards to, or on behalf of;
9) Credit Payment Card Funding: payment processer transfers funds from a user’s payment processer account balance to repay a negative credit payment card balance issued by the payment processer or financial institution with which the payment processer has partnered to issue cards to, or on behalf of its partners;
10) Treasury Account Funding: funds sent by a user, or a third-party sender (on behalf of the user) to the sender’s virtual prepaid account held by the payment processer’s financial partner and managed by the payment processer; and
11) Payment Account Funding: the payment processer transfers funds from a user’s payment processer account to the user’s external account held by a third-party financial institution.

In this context, the user is a person that is currently contracted with the payment processer for applicable payment processer products and services not all users have contracted for all payment processer products or services.

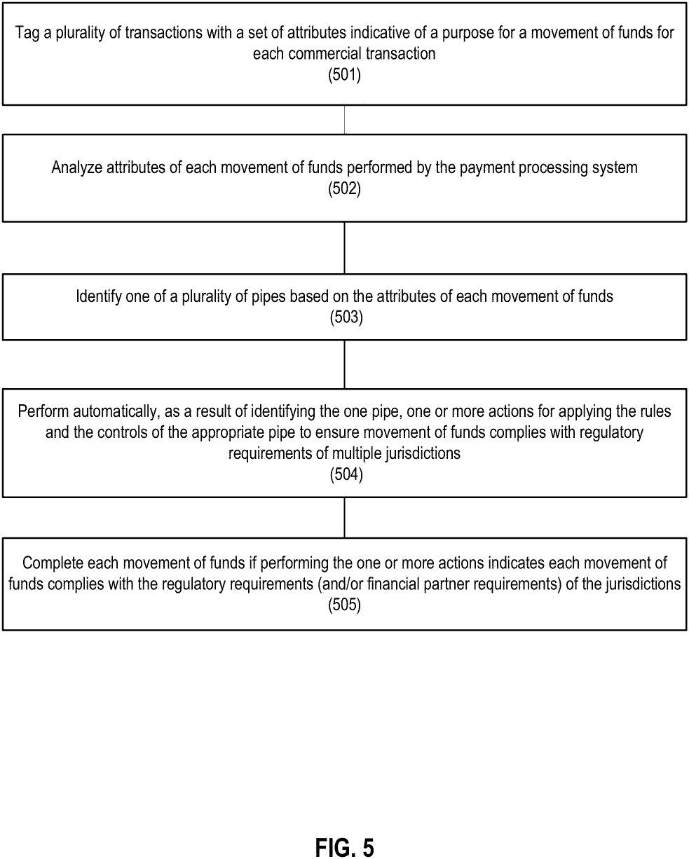

FIG. 5 is a data flow diagram of some embodiments of a process for handling movements of funds. In some embodiments, the process is performed by processing logic that may comprise hardware (circuitry, dedicated logic, etc.), software (e.g., software running on a chip), firmware, or a combination of the three. In some embodiments, the movements of funds are handled, at least in part, by a payment processor and the process is performed by a payment processing system of a payment processor.

Referring to FIG. 5, the process begins by processing logic tagging a plurality of transactions with a set of attributes indicative of a purpose for a movement of funds for each commercial transaction (processing block 501). In some embodiments, performing these actions evaluates the movement of funds with respect to a set of requirements that must be met for the purpose.

After tagging of transactions, processing logic analyzing attributes of each movement of funds performed by the payment processing system (processing block 502) and identifying one of a plurality of pipes based on the attributes of each movement of funds (processing logic 503). In some embodiments, each of these pipes has one or more rules that include one or more gates to determine whether funds may be moved between sender and receiver accounts designated for each movement of funds and one or more controls to apply during or after each movement of the funds.

Next, processing logic performs automatically, as a result of identifying the one pipe, one or more actions for applying the rules and the controls of the appropriate pipe to ensure movement of funds complies with regulatory requirements of multiple jurisdictions (processing block 504). In some embodiments, performing the actions ensures that each movement of funds is in accordance with contractual requirements of one or more financial partners. In some embodiments, the multiple jurisdictions comprise all jurisdictions for which at least a part of each movement of funds is performed by the payment processing system.

In some embodiments, the plurality of pipes is associated with a plurality of movements of funds related to payment processing operations of the payment processing system, and each movements of funds of the plurality of movements of funds is represented as a series of transactions between originating and destination accounts indicative of a sequence of individual flow funds takes into, within and from the payment processing system. In some embodiments, the pipes have one or more gates through which the movement of funds must pass to manage regulatory requirements based on purpose of the money movement. In some embodiments, each action of the one or more actions comprises applying a policy that restricts a type of activity. In some embodiments, two or more pipes of the plurality of pipes are linked together.

By performing the actions associated with each pipe, processing logic completes each movement of funds if performing the one or more actions indicates each movement of funds complies with the regulatory requirements (and/or financial partner requirements) of the jurisdictions (processing block 505).

### An Example of a Computer System

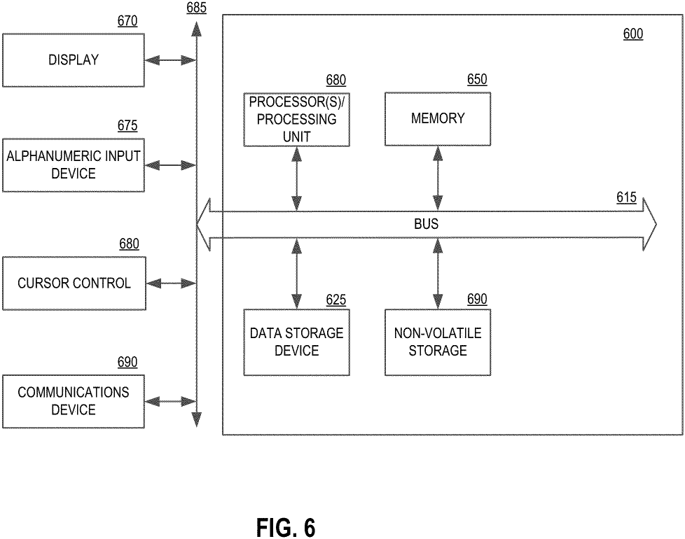

FIG. 6 is some embodiments of a computer system that may be used to support the systems and operations discussed herein. It will be apparent to those of ordinary skill in the art, however that other alternative systems of various system architectures may also be used.

The data processing system illustrated in FIG. 6 includes a bus or other internal communication means 615 for communicating information, and a processor(s) 610 coupled to the bus 615 for processing information. The system further comprises a random-access memory (RAM) or other volatile storage device 650 (referred to as memory), coupled to bus 615 for storing information and instructions to be executed by processor 610. Main memory 650 also may be used for storing temporary variables or other intermediate information during execution of instructions by processor(s) 610. The system also comprises a read only memory (ROM) and/or static storage device 620 coupled to bus 615 for storing static information and instructions for processor 610, and a data storage device 625 such as a magnetic disk or optical disk and its corresponding disk drive. Data storage device 625 is coupled to bus 615 for storing information and instructions.

The system may further be coupled to a display device 670, such as a light emitting diode (LED) display or a liquid crystal display (LCD) coupled to bus 615 through bus 665 for displaying information to a computer user. An alphanumeric input device 675, including alphanumeric and other keys, may also be coupled to bus 615 through bus 665 for communicating information and command selections to processor 610. An additional user input device is cursor control device 680, such as a touchpad, mouse, a trackball, stylus, or cursor direction keys coupled to bus 615 through bus 665 for communicating direction information and command selections to processor 610, and for controlling cursor movement on display device 670.

Another device, which may optionally be coupled to computer system 600, is a communication device 690 for accessing other nodes of a distributed system via a network. The communication device 690 may include any of a number of commercially available networking peripheral devices such as those used for coupling to an Ethernet, token ring, Internet, or wide area network. The communication device 690 may further be a null-modem connection, or any other mechanism that provides connectivity between the computer system 600 and the outside world. Note that any or all of the components of this system illustrated in FIG. 6 and associated hardware may be used in various embodiments as discussed herein.

In some embodiments, processor(s) 610 generates regulatory and contract rules of a regulatory and contract layers and maps terms in the regulatory rules to activities associated with the movement of funds and other such activities of the payment processor or other entity in the commercial transactions as described above. In some embodiments, processor(s) 610 executes the pipes and the actions with respect to the pipes, including determining and applying licensing requirements, go and no-go gates and the controls of a pipe.

It will be appreciated by those of ordinary skill in the art that any configuration of the system may be used for various purposes according to the particular implementation. The control logic or software implementing the described embodiments can be stored in main memory 650, mass storage device 625, or other storage medium locally or remotely accessible to processor 610.

It will be apparent to those of ordinary skill in the art that the system, method, and process described herein can be implemented as software stored in main memory 650 or read only memory 620 and executed by processor 610. This control logic or software may also be resident on an article of manufacture comprising a computer readable medium having computer readable program code embodied therein and being readable by the mass storage device 625 and for causing the processor 610 to operate in accordance with the methods and teachings herein.

The embodiments discussed herein may also be embodied in a handheld or portable device containing a subset of the computer hardware components described above. For example, the handheld device may be configured to contain only the bus 685, the processor 610, and memory 650 and/or 625. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 610, a data storage device 625, a bus 615, and memory 650, and only rudimentary communications mechanisms, such as a small touch-screen that permits the user to communicate in a basic manner with the device. In general, the more special-purpose the device is, the fewer of the elements need be present for the device to function.

There is a number of example embodiments described herein.

Example 1 is a method comprising: analyzing, by a payment processing system, attributes of each movement of funds performed by the payment processing system; identifying, by the payment processing system, one of a plurality of pipes based on the attributes of said each movement of funds, each pipe of the plurality of pipes having one or more rules that include one or more gates to determine whether funds may be moved, by the payment processing system, between sender and receiver accounts designated for said each movement of funds and one or more controls to apply during or after said each movement of the funds; performing, automatically by the payment processing system as a result of identifying the one pipe, one or more actions for applying the one or more rules and the one or more controls of the one pipe to ensure said each movement of funds complies with regulatory requirements of a plurality of jurisdictions; and completing, by the payment processing system, said each movement of funds if performing the one or more actions indicates said each movement of funds complies with the regulatory requirements of a plurality of jurisdictions.

Example 2 is the method of example 1 that may optionally include that the plurality of jurisdictions comprises all jurisdictions for which at least a part of said each movement of funds is performed by the payment processing system.

Example 3 is the method of example 1 that may optionally include that performing the one or more actions ensures that said each movement of funds is in accordance with contractual requirements of one or more financial partners.

Example 4 is the method of example 1 that may optionally include tagging each of a plurality of commercial transactions with a set of attributes indicative of a purpose for a movement of funds for said each commercial transaction, wherein performing the one or more actions evaluates the movement of funds with respect to a set of requirements that must be met for the purpose.

Example 5 is the method of example 1 that may optionally include that two or more pipes of the plurality of pipes are linked together.

Example 6 is the method of example 1 that may optionally include that the pipes have one or more gates through which the movement of funds must pass to manage regulatory requirements based on purpose of the money movement.

Example 7 is the method of example 1 that may optionally include that the plurality of pipes are associated with a plurality of movements of funds related to payment processing operations of the payment processing system, and each movements of funds of the plurality of movements of funds is represented as a series of transactions between originating and destination accounts indicative of a sequence of individual flow funds takes into, within and from the payment processing system.

Example 8 is the method of example 1 that may optionally include that each action of the one or more actions comprises applying a policy that restricts a type of activity.

Example 9 is an example of a non-transitory computer readable storage media having instructions stored thereupon which, when executed by a system having at least a processor and a memory therein, cause the system to perform operations comprising: analyzing, by a payment processing system, attributes of each movement of funds performed by the payment processing system; identifying, by the payment processing system, one of a plurality of pipes based on the attributes of said each movement of funds, each pipe of the plurality of pipes having one or more rules that include one or more gates to determine whether funds may be moved, by the payment processing system, between sender and receiver accounts designated for said each movement of funds and one or more controls to apply during or after said each movement of the funds; performing, automatically by the payment processing system as a result of identifying the one pipe, one or more actions for applying the one or more rules and the one or more controls of the one pipe to ensure said each movement of funds complies with regulatory requirements of a plurality of jurisdictions; and completing, by the payment processing system, said each movement of funds if performing the one or more actions indicates said each movement of funds complies with the regulatory requirements of a plurality of jurisdictions.

Example 10 is the non-transitory computer readable storage media of example 9 that may optionally include that the plurality of jurisdictions comprises all jurisdictions for which at least a part of said each movement of funds is performed by the payment processing system.

Example 11 is the non-transitory computer readable storage media of example 9 that may optionally include that performing the one or more actions ensures that said each movement of funds is in accordance with contractual requirements of one or more financial partners.

Example 12 is the non-transitory computer readable storage media of example 9 that may optionally include that the operations further comprise tagging each of a plurality of commercial transactions with a set of attributes indicative of a purpose for a movement of funds for said each commercial transaction, wherein performing the one or more actions evaluates the movement of funds with respect to a set of requirements that must be met for the purpose.

Example 13 is the non-transitory computer readable storage media of example 9 that may optionally include that two or more pipes of the plurality of pipes are linked together.

Example 14 is the non-transitory computer readable storage media of example 9 that may optionally include that the pipes have one or more gates through which the movement of funds must pass to manage regulatory requirements based on purpose of the money movement.

Example 15 is a payment processing system to process transactions that comprises: a memory to store instructions; and one or more processors to execute the stored instructions to analyze attributes of each movement of funds performed by the payment processing system; identify one of a plurality of pipes based on the attributes of said each movement of funds, each pipe of the plurality of pipes having one or more rules that include one or more gates to determine whether funds may be moved between sender and receiver accounts designated for said each movement of funds and one or more controls to apply during or after said each movement of the funds; perform automatically, as a result of identifying the one pipe, one or more actions for applying the one or more rules and the one or more controls of the one pipe to ensure said each movement of funds complies with regulatory requirements of a plurality of jurisdictions; and complete said each movement of funds if performing the one or more actions indicates said each movement of funds complies with the regulatory requirements of a plurality of jurisdictions.

Example 16 is the payment processing system of example 15 that may optionally include that the plurality of jurisdictions comprises all jurisdictions for which at least a part of said each movement of funds is performed by the payment processing system.

Example 17 is the payment processing system of example 15 that the one or more processors perform the one or more actions to ensure that said each movement of funds is in accordance with contractual requirements of one or more financial partners.

Example 18 is the payment processing system of example 15 that the one or more processors are operable to tag each of a plurality of commercial transactions with a set of attributes indicative of a purpose for a movement of funds for said each commercial transaction, wherein performing the one or more actions evaluates the movement of funds with respect to a set of requirements that must be met for the purpose.

Example 19 is the payment processing system of example 15 that two or more pipes of the plurality of pipes are linked together.

Example 20 is the payment processing system of example 15 that the pipes have one or more gates through which the movement of funds must pass to manage regulatory requirements based on purpose of the money movement.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

1. A method comprising:
electronically receiving, by a payment processing system, a plurality of commercial transactions;
representing each of the plurality of commercial transactions involving a movement of funds as a series of transactions between accounts;
tagging, by the payment processing system, each movement of funds as regulated or not based on movement of funds type between accounts, comprising:
mapping, by a global tagging system (GTS) of the payment processing system, the one or more types of movement of funds to data models, wherein the tagging of said each movement of funds is with a set of attributes indicative of a purpose for the movement of funds for said each movement of funds, wherein the tagging is based, at least in part, on a mapping of regulatory terms of regulatory rules written in a regulatory layer to different movements of funds performed by the payment processing system;
analyzing, by the payment processing system, attributes of each movement of funds performed by the payment processing system;
identifying, by the payment processing system, one of a plurality of pipes based on the attributes of said each movement of funds for handling each commercial transaction of the plurality of commercial transactions, each pipe of the plurality of pipes for handling a different movement of funds and having one or more rules that include one or more gates to determine whether funds may be moved, by the payment processing system, between sender and receiver accounts designated for said each movement of funds and one or more controls to apply during or after said each movement of the funds, wherein two or more pipes of the plurality of pipes are linked together to avoid multiple repetitive mappings, wherein the one or more controls includes an eligible securities control to determine whether an eligible security with a holding requirement is associated with said each movement of the funds and to complete said each movement of the funds in response to the holding requirement associated with the eligible security being satisfied;
performing, automatically by the payment processing system as a result of identifying the one pipe, one or more actions for applying the one or more rules and the one or more controls of the one pipe to ensure said each movement of funds complies with regulatory requirements of a plurality of jurisdictions, comprising:
using, by the payment processing system, the one or more gates to determine whether the sender or receiver accounts are on a restricted business list; and
completing, by the payment processing system, said each movement of funds if performing the one or more actions indicates said each movement of funds complies with the regulatory requirements of a plurality of jurisdictions.

2. The method of claim 1 wherein the plurality of jurisdictions comprises all jurisdictions for which at least a part of said each movement of funds is performed by the payment processing system.

3. The method of claim 1 wherein performing the one or more actions ensures that said each movement of funds is in accordance with contractual requirements of one or more financial partners.

4. The method of claim 1 wherein performing the one or more actions evaluates the movement of funds with respect to a set of requirements that must be met for the purpose.

5. (canceled)

6. The method of claim 1 wherein the pipes have one or more gates through which the movement of funds must pass to manage regulatory requirements based on purpose of the money movement.

7. The method defined in claim 1 wherein the plurality of pipes are associated with a plurality of movements of funds related to payment processing operations of the payment processing system, and each movements of funds of the plurality of movements of funds is represented as a series of transactions between originating and destination accounts indicative of a sequence of individual flow funds takes into, within and from the payment processing system.

8. The method defined in claim 1 wherein each action of the one or more actions comprises applying a policy that restricts a type of activity.

9. Non-transitory computer readable storage media having instructions stored thereupon which, when executed by a system having at least a processor and a memory therein, cause the system to perform operations comprising:
electronically receiving, by a payment processing system, a plurality of commercial transactions;
representing each of the plurality of commercial transactions involving a movement of funds as a series of transactions between accounts;
tagging, by the payment processing system, each movement of funds as regulated or not based on movement of funds type between accounts, comprising:
mapping, by a global tagging system (GTS) of the payment processing system, the one or more types of movement of funds to data models, wherein the tagging of said each movement of funds is with a set of attributes indicative of a purpose for the movement of funds for said each movement of funds, wherein the tagging is based, at least in part, on a mapping of regulatory terms of regulatory rules written in a regulatory layer to different movements of funds performed by the payment processing system;
analyzing, by the payment processing system, attributes of each movement of funds performed by the payment processing system;
identifying, by the payment processing system, one of a plurality of pipes based on the attributes of said each movement of funds for handling each commercial transaction of the plurality of commercial transactions, each pipe of the plurality of pipes for handling a different movement of funds and having one or more rules that include one or more gates to determine whether funds may be moved, by the payment processing system, between sender and receiver accounts designated for said each movement of funds and one or more controls to apply during or after said each movement of the funds, wherein two or more pipes of the plurality of pipes are linked together to avoid multiple repetitive mappings, wherein the one or more controls includes an eligible securities control to determine whether an eligible security with a holding requirement is associated with said each movement of the funds and to complete said each movement of the funds in response to the holdings requirement associated with the eligible security being satisfied;
performing, automatically by the payment processing system as a result of identifying the one pipe, one or more actions for applying the one or more rules and the one or more controls of the one pipe to ensure said each movement of funds complies with regulatory requirements of a plurality of jurisdictions, comprising:
using, by the payment processing system, the one or more gates to determine whether the sender or receiver accounts are on a restricted business list; and
completing, by the payment processing system, said each movement of funds if performing the one or more actions indicates said each movement of funds complies with the regulatory requirements of a plurality of jurisdictions.

10. The non-transitory computer readable storage media defined in claim 9 wherein
wherein the plurality of jurisdictions comprises all jurisdictions for which at least a part of said each movement of funds is performed by the payment processing system.

11. The non-transitory computer readable storage media defined in claim 9 wherein performing the one or more actions ensures that said each movement of funds is in accordance with contractual requirements of one or more financial partners.

12. The non-transitory computer readable storage media defined in claim 9 wherein performing the one or more actions evaluates the movement of funds with respect to a set of requirements that must be met for the purpose.

13. (canceled)

14. The non-transitory computer readable storage media defined in claim 9 wherein the pipes have one or more gates through which the movement of funds must pass to manage regulatory requirements based on purpose of the money movement.

15. A payment processing system to process transactions, the payment processing system comprising:
a communication device to electronically receive a plurality of commercial transactions;
a memory to store instructions; and
one or more processors coupled to the memory and the communication device to execute the stored instructions to
represent each of the plurality of commercial transactions involving a movement of funds as a series of transactions between accounts;
tag each movement of funds as regulated or not based on movement of funds type between accounts, wherein the one or more processors are to execute the stored instructions to map, by a global tagging system (GTS) of the payment processing system, the one or more types of movement of funds to data models, wherein the tagging of said each movement of funds is with a set of attributes indicative of a purpose for the movement of funds for said each movement of funds, wherein the tagging is based, at least in part, on a mapping of regulatory terms of regulatory rules written in a regulatory layer to different movements of funds performed by the payment processing system;
analyze attributes of each movement of funds performed by the payment processing system;
identify one of a plurality of pipes based on the attributes of said each movement of funds for handling each commercial transaction of the plurality of commercial transactions, each pipe of the plurality of pipes for handling a different movement of funds and having one or more rules that include one or more gates to determine whether funds may be moved, by the payment processing system, between sender and receiver accounts designated for said each movement of funds and one or more controls to apply during or after said each movement of the funds, wherein two or more pipes of the plurality of pipes are linked together to avoid multiple repetitive mappings, wherein the one or more controls includes an eligible securities control to determine whether an eligible security with a holding requirement is associated with said each movement of the funds and to complete said each movement of the funds in response to the holdings requirement associated with the eligible security being satisfied;
perform automatically, as a result of identifying the one pipe, one or more actions for applying the one or more rules and the one or more controls of the one pipe to ensure said each movement of funds complies with regulatory requirements of a plurality of jurisdictions, wherein the one or more processors are to execute the stored instructions to: use, by the payment processing system, the one or more gates to determine whether the sender or receiver accounts are on a restricted business list; and
complete said each movement of funds if performing the one or more actions indicates said each movement of funds complies with the regulatory requirements of a plurality of jurisdictions.

16. The payment processing system of claim 15 wherein the plurality of jurisdictions comprises all jurisdictions for which at least a part of said each movement of funds is performed by the payment processing system.

17. The payment processing system of claim 15 wherein the one or more processors perform the one or more actions to ensure that said each movement of funds is in accordance with contractual requirements of one or more financial partners.

18. The payment processing system of claim 15 wherein performing the one or more actions evaluates the movement of funds with respect to a set of requirements that must be met for the purpose.

19. (canceled)

20. The payment processing system of claim 15 wherein the pipes have one or more gates through which the movement of funds must pass to manage regulatory requirements based on purpose of the money movement.
